(19) United States
(12) Patent Application Publication
(10) Pub. No.: US 2020/0090378 A1
(43) Pub. Date: Mar. 19, 2020

(54) SYSTEMS AND METHODS FOR IMPROVED IMAGE RECONSTRUCTION

(71) Applicant: General Electric Company, Schenectady, NY (US)

(72) Inventors: Mohammed Mehdi Khalighi, Menlo Park, CA (US); Floribertus PM Heukensfeldt Jansen, Niskayuna, NY (US); Charlotte Roche Hoo, Chicago, IL (US)

(21) Appl. No.: 16/131,800

(22) Filed: Sep. 14, 2018

(51) Int. Cl. G06T 11/00; G06F 17/11; G06T 5/20

(52) U.S. Cl. CPC G06T 11/003; G06F 17/11; G06T 2207/10104; G06T 2211/424; G06T 5/20

(57) ABSTRACT

A method is provided that includes acquiring scanning information for a positron emission tomography (PET) scan. The scanning information includes time information. The method also includes generating imaging information using the scanning information. Further, the method also includes modifying the imaging information using the time information to generate modified imaging information, and reconstructing an image using the modified imaging information.

### BACKGROUND OF THE INVENTION

The subject matter disclosed herein relates generally to apparatus and methods for diagnostic medical imaging, such as positron emission tomography (PET) imaging.

PET image reconstruction may be divided into two main categories: sinogram-based reconstruction, and list mode-based reconstruction. In sinogram-based image reconstruction such as TOF-OSEM all coincidence events are read from a list file and used to generate a sinogram, which is then used for PET image reconstruction. In this type of reconstruction, temporal information regarding coincidence events within the list file is lost after forming the sinogram. Further, in both sinogram-based and list-mode based techniques, various conventional approaches assume that time-based effects such as biological kinetics of a radiotracer are negligible, and accordingly fail to account for such effects.

### BRIEF DESCRIPTION OF THE INVENTION

In one embodiment, a method is provided that includes acquiring scanning information for a positron emission tomography (PET) scan. The scanning information includes time information. The method also includes generating list mode imaging information using the scanning information. Further, the method also includes modifying the list mode imaging information using the time information to generate modified list mode imaging information, and reconstructing an image using the modified list mode imaging information.

In another embodiment, a method is provided that includes acquiring scanning information for a positron emission tomography (PET) scan. The scanning information includes time information. The method also includes dividing the scanning information into subsets using the time information and generating an initial list mode image using the scanning information. Further, the method includes separately updating the initial list mode image with each subset to generate corresponding modified list mode images, and generating a final image using the modified list mode images.

In another embodiment, a system is provided that includes a positron emission tomography (PET) acquisition unit and at least one processor. The PET acquisition unit is configured to acquire PET imaging information. The at least one processor is operably coupled to the PET acquisition unit, and is configured to acquire scanning information from the PET acquisition unit, the scanning information including time information; divide the scanning information into subsets using the time information; generate an initial list mode image using the scanning information; separately update the initial list mode image with each subset to generate corresponding modified images; and generate a final image using the modified images.

### BRIEF DESCRIPTION OF THE DRAWINGS

FIG. 1 provides a flowchart of a method in accordance with various embodiments.

FIG. 2 provides a flowchart of a method in accordance with various embodiments.

FIG. 3 provides a flowchart of a method in accordance with various embodiments.

FIG. 4 provides a schematic block view of an imaging system in accordance with various embodiments.

FIG. 5 illustrates an imaging system in accordance with various embodiments.

FIG. 6 is a schematic diagram of the imaging system of FIG. 5.

FIG. 7 illustrates an example of a detector module which forms part of the imaging system in accordance with various embodiments.

### DETAILED DESCRIPTION OF THE INVENTION

The following detailed description of certain embodiments will be better understood when read in conjunction with the appended drawings. To the extent that the figures illustrate diagrams of the functional blocks of various embodiments, the functional blocks are not necessarily indicative of the division between hardware circuitry. For example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. Various modules or units shown in the attached figures may represent the hardware that operates based on software or hardwired instructions, the software that directs hardware to perform the operations, or a combination thereof.

“Systems,” “units,” or “modules” may include or represent hardware and associated instructions (e.g., software stored on a tangible and non-transitory computer readable storage medium, such as a computer hard drive, ROM, RAM, or the like) that perform one or more operations described herein. The hardware may include electronic circuits that include and/or are connected to one or more logic-based devices, such as microprocessors, processors, controllers, or the like. These devices may be off-the-shelf devices that are appropriately programmed or instructed to perform operations described herein from the instructions described above. Additionally or alternatively, one or more of these devices may be hard-wired with logic circuits to perform these operations.

As used herein, an element or step recited in the singular and preceded with the word “a” or “an” should be understood as not excluding plural of said elements or steps, unless such exclusion is explicitly stated. Furthermore, references to “one embodiment” of are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Various systems and methods disclosed herein address drawbacks of current systems. For example, when a significant variation in uptake with time is expected, conventional techniques reconstruct multiple data frames independently, and attempts to account for rapid change in activity require short frame durations, resulting in increased noise. In contrast, various embodiments disclosed herein mitigate the problem of variation in uptake with time by allowing the reconstruction of low-noise, time-varying images that accurately represent the temporal variation in uptake.

Various embodiments provide systems and methods for improving the image quality of PET images. For example, various embodiments utilize time information in connection with scanning information (e.g., list mode information) to address time-related variations in imaging information (e.g., due to biologic kinetics of a radiotracer). For example, imaging data may be separated into chronological subsets. After initial reconstruction using a list-mode reconstruction technique, the counts of each subset may be used to perform an update on the initially reconstructed image, resulting in a modified image for each subset. The images from all of the subsets may then be averaged, filtered, or otherwise processed through time to generate a final image.

Various conventional PET image reconstruction techniques ignore temporal statistics information for coincidence events. For example, in many cases of PET imaging, the patient is scanned well after the injection and it is assumed that the biodistribution of the tracer is time invariant during data acquisition. It may be noted that even in dynamic PET imaging where the tracer is injected after the imaging is started, the biological kinetics of the tracer after a few tens of seconds tends to slow down, with smaller temporal changes in the coincidence events statistics. These effects, while reduced with time after injection, may still have an effect on the imaging process and accordingly on image quality. Various embodiments disclosed herein utilize time information of coincidence events to improve final image quality.

A technical effect provided by various embodiments includes improved image quality (e.g., improved signal-to-noise ratio (SNR)). A technical effect provided by various embodiments includes accounting for biological kinetics of radiotracers and/or other time effects that uniquely affect a particular scan. A technical effect provided by various embodiments includes facilitating imaging more closely to time of injection (e.g., by better addressing variances in time of radiotracer behavior, which are more pronounced closer to the time of injection). A technical effect provided by various embodiments includes the ability to trade off an increase in SNR with a lowering of dose.

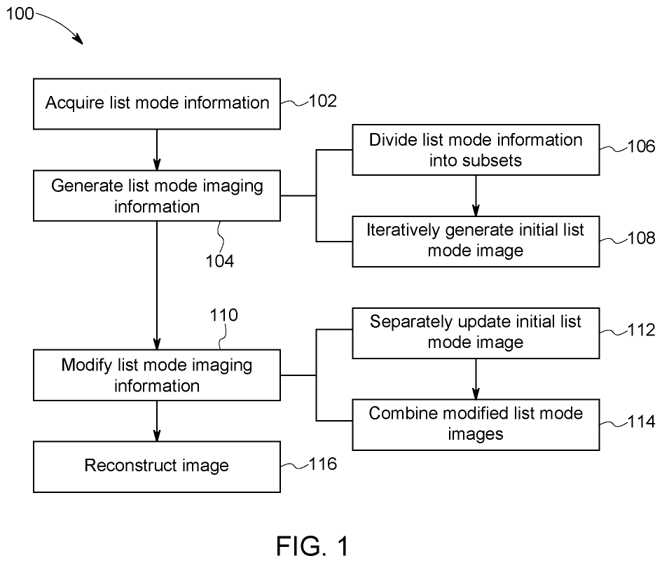

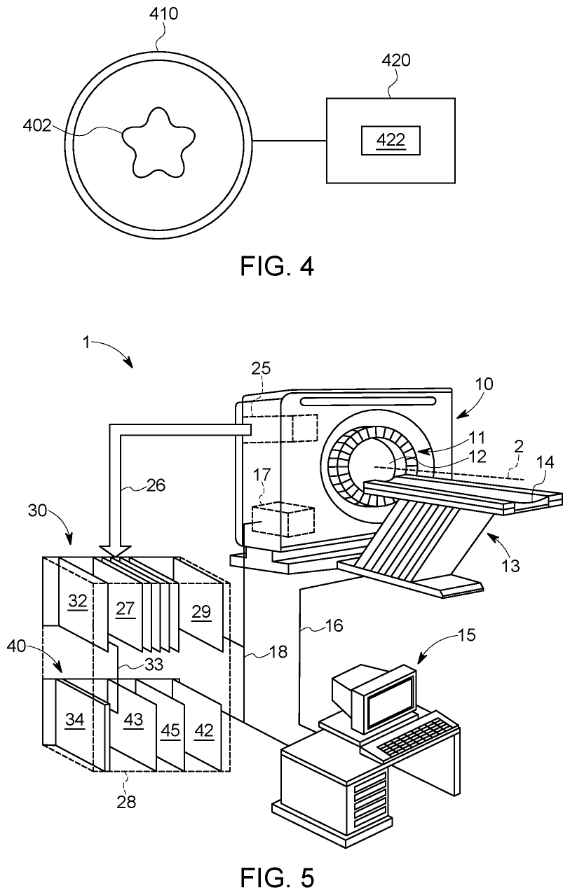

FIG. 1 provides a flowchart of a method 100 (e.g., for reconstructing a PET image), in accordance with various embodiments. The method 100, for example, may employ or be performed by structures or aspects of various embodiments (e.g., systems and/or methods and/or process flows) discussed herein. In various embodiments, certain steps may be omitted or added, certain steps may be combined, certain steps may be performed concurrently, certain steps may be split into multiple steps, certain steps may be performed in a different order, or certain steps or series of steps may be re-performed in an iterative fashion. In various embodiments, portions, aspects, and/or variations of the method 100 may be able to be used as one or more algorithms to direct hardware (e.g., one or more aspects of the processing unit 420 discussed in connection with FIG. 4) to perform one or more operations described herein.

At 102, scanning information (list mode information in the illustrated embodiment) is acquired for a positron emission tomography (PET) scan. The list mode information includes time information. As used herein, time information may be understood as information that identifies or corresponds to a time at which a coincidence event (an event detected by two detectors at or near the same time) is detected relative to the beginning of a scan, or other reference time. Accordingly, all events for a given scan may be ordered sequentially (chronologically) based on the time information of the events. The list mode information may also include an identification of the two detectors associated with the event, as well as time-of-flight (TOF) information that may be used to determine a relative distance of the event between the two detectors that may be used to identify the approximate location of occurrence of events for use in image reconstruction. It may be noted that in connection with the illustrated embodiments, list mode information is discussed. However, in connection with alternate embodiments, other scanning information may be acquired or other types of reconstruction techniques may be employed.

At 104, list mode imaging information (as an example of a type of imaging information) is generated using the list mode information (as an example of a type of scanning information). The list mode imaging information in various embodiments includes one or more initial images that are reconstructed with or without use of the time information. It may be noted that for embodiments that use other scanning information than list mode information, the imaging information (e.g., one or more reconstructed images) may be generated using that scanning information.) In the illustrated example, at 106, the list mode information is divided into subsets using the time information, and at 108, the subsets are used to iteratively generate the initial list mode image. For example, at 106, using the time information, the subsets may be ordered into similarly sized (e.g., same number of counts or events) subsets separated by time. The earliest acquired counts may be grouped into a first subset, the second-earliest acquired group of counts grouped into a second subset, and so on, until the last group of counts is grouped into a last subset. In various embodiments, a number of the subsets contain a common number of counts, so that image quality among the different subsets is similar. For example, each subset may be formed of 5 megacounts (e.g., the first 5 megacounts acquired forming a first subset, the next 5 megacounts acquired forming a second subset, and so on), with the exception of the last subset, which includes a remainder of counts after all previous subsets are formed. Then, at 108, each subset may be used in turn to update a preliminary estimated image as part of an iterative list mode reconstruction process to generate or reconstruct an initial list mode image.

At 110, the list mode imaging information is modified using the time information to generate modified list mode imaging information. It may be noted that the time information may be used directly to modify the list mode imaging information (e.g., by weighting data more or less heavily based on the time of detection and a relative strength or weakness of expected signals based on the time of the detection due to decay and/or biologic kinetics of a radiotracer), and/or indirectly. An example of indirect modification includes generating different modified images using different subsets grouped by time of acquisition.

For instance, a group of modified images (e.g., modified from the initial list mode image) may be generated using corresponding subsets grouped by time of acquisition, and the group of modified images then combined using filtering and/or averaging to provide an image. For example, in the embodiment illustrated in FIG. 1, modifying the list mode imaging information includes, at 112, separately updating the initial list mode image with each subset (e.g., subsets formed at 106 or otherwise grouped based on the time information) to generate corresponding modified list mode images. The modified list mode images may then be processed and/or combined to generate a final image. For example, in the illustrated example, at 114, the modified list mode images are combined using at least one of a filtering or an averaging process. For example, a weighted averaging process may be used. Additionally or alternatively, root mean square information may be determined for the modified list mode images. Further additionally or alternatively, high pass and/or low pass filters may be applied.

At 116, an image is reconstructed using the modified list mode imaging information. For example, the modified list mode images generated at 114 may be used to generate the image. By using the time information to generate the image, issues that affect the scanning process over time, including issues unique to a particular scan (e.g., biologic kinetics of a radiotracer in a particular patient for a particular procedure) may be addressed.

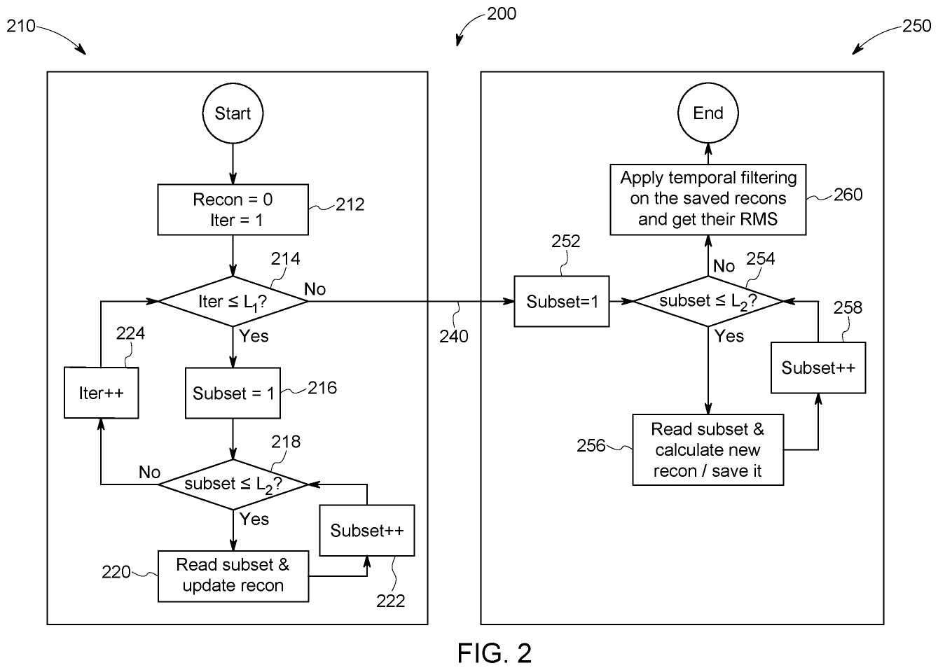

FIG. 2 provides a flowchart of a method 200 (e.g., for reconstructing a PET image), in accordance with various embodiments. The method 200, for example, may employ or be performed by structures or aspects of various embodiments (e.g., systems and/or methods and/or process flows) discussed herein. In various embodiments, certain steps may be omitted or added, certain steps may be combined, certain steps may be performed concurrently, certain steps may be split into multiple steps, certain steps may be performed in a different order, or certain steps or series of steps may be re-performed in an iterative fashion. In various embodiments, portions, aspects, and/or variations of the method 200 may be able to be used as one or more algorithms to direct hardware (e.g., one or more aspects of the processing unit 420 discussed in connection with FIG. 4) to perform one or more operations described herein. It may be noted the method 200 provides an example of aspects of the method 100, where time information that forms part of list mode information is used to indirectly modify list mode imaging information (e.g., via the use of time-grouped subsets to individually modify an initial image). It may be noted that the flowchart of method 200, similar to the flowchart of method 100 and other illustrated embodiments discussed herein, is discussed in relation to an example embodiment using list mode information and list mode images; however, other types of scanning information and/or reconstruction techniques (e.g., use of sinograms) may be used in other embodiments.

The flowchart of method 200 is divided into a first portion 210 (on the left side) and a second portion 250 (on the right side). Generally, the first portion 210 produces an initial list mode image 240 that is provided to the second portion 250 where the initial list mode image 240 is modified (e.g., using time information). Generally, the method 200 reads subset of coincidence events and performs reconstruction on the subsets to avoid memory and/or processing limitations that may be encountered by attempting to reconstruct an entire data set at once. The method 200 employs L₁ iterations and L₂ subsets. The particular values for L₁ and L₂ may be selected or tailored based on one or more of patient information, available processing capability, particular procedure, and/or user preferences. As seen in FIG. 2, after an initial image reconstruction to generate the initial list mode image 240, another image update is performed using the counts of each subset in the second portion 250. In the illustrated embodiment, each subset has a pre-defined equal number of events (except the last subset). Accordingly, the reconstructed images from each subset have similar image quality. The images from all subsets are then filtered and/or averaged through time, and the final image is obtained.

As seen in FIG. 2, at 212, an iterative reconstruction process begins. At 214, 216, 218, 220, 222, and 224, the process cycles through the subsets and iterations. For each iteration, an initial estimated image is updated sequentially by each subset, until the image has been updated by all subsets. It may be noted that for the first portion 210, a single image is continuously updated by the subsets in turn through the iterations, such that when all iterations of updates are complete, a single initial list mode image 240 is generated and provided to the second portion 250 of the method 200. However, in the second portion, the initial list mode image is separately or individually updated by each subset to form a unique or individual modified image for each particular sub set.

Then at 252, the second portion 250 commences for the first subset, or with the current subset set at 1 (e.g., the subset of earliest acquired events). At 254, as long as there is at least one remaining subset, the method 200 proceeds to 256. At 256, the current subset is read, use to generate an update of the initial list mode image 240, and the update is saved. At 258, the subset is incremented and the method proceeds to 254. Accordingly, a different modified image is generated and saved for each subset (e.g., a modified image generated by updating the initial list mode image with the particular subset). In the illustrated embodiment, the initial list mode image 240 is an input for step 256 each time step 256 is performed, with the initial list mode image 240 accordingly separately modified by each subset, and a separate corresponding modified image generated for each subset. Once all subsets have been used to generate a corresponding modified image, the method 200 proceeds to 260. At 260, the modified images generated and saved at 256 are averaged, filtered, or otherwise combined, and a root mean square is determined. The final image may then be obtained using the root mean square.

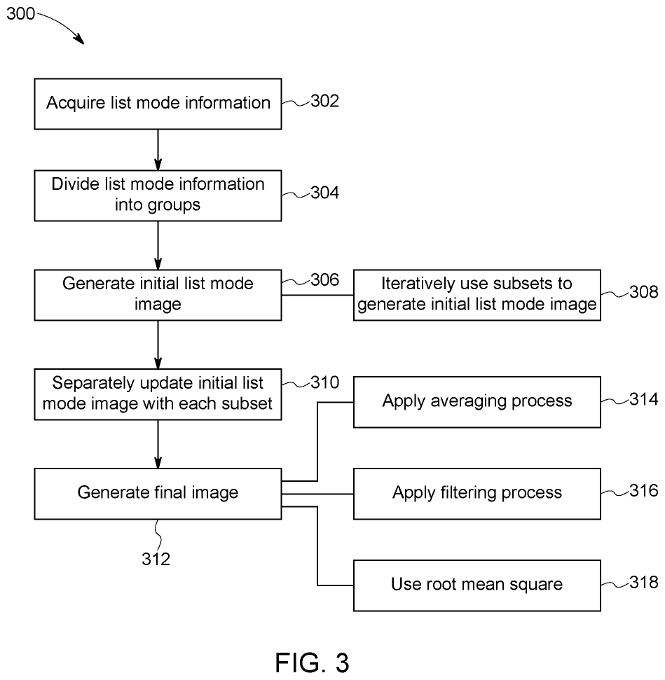

FIG. 3 provides a flowchart of a method 300 (e.g., for reconstructing a PET image), in accordance with various embodiments. The method 300, for example, may employ or be performed by structures or aspects of various embodiments (e.g., systems and/or methods and/or process flows) discussed herein. In various embodiments, certain steps may be omitted or added, certain steps may be combined, certain steps may be performed concurrently, certain steps may be split into multiple steps, certain steps may be performed in a different order, or certain steps or series of steps may be re-performed in an iterative fashion. In various embodiments, portions, aspects, and/or variations of the method 300 may be able to be used as one or more algorithms to direct hardware (e.g., one or more aspects of the processing unit 420 discussed in connection with FIG. 4) to perform one or more operations described herein. It may be noted that the method 200 provides an example of aspects of the method 300. It may be noted that the flowchart of method 300, similar to the flowchart of method 100 and other illustrated embodiments discussed herein, is discussed in relation to an example embodiment using list mode information and list mode images; however, other types of scanning information and/or reconstruction techniques (e.g., use of sinograms) may be used in other embodiments.

At 302, list mode information is acquired for a positron emission tomography (PET) scan. The list mode information in various embodiments includes time information (e.g., timing that identifies or corresponds to a time at which a coincidence event (event detected by two detectors at or near the same time) is detected relative to the beginning of a scan). Accordingly, as discussed herein, using the time information, all events for a given scan may be ordered and/or grouped sequentially or chronologically. It may be noted that the list mode information may also include an identification of the two detectors associated with the event, as well as time-of-flight (TOF) information that may be used to determine a relative distance of the event between the two detectors.

At 304, the list mode information is divided into subsets using the time information. For example, the counts from a given scan may be separated into sequential or chronological subsets that contain a common number of counts. The number of counts may be selected to provide a sufficient image quality for each subset. For example, in various embodiments, 1 megacount, 5 megacounts, or 20 megacounts per subset may be utilized. In the case of using 20 megacounts, for example, and with 1990 megacounts detected for a scan, the list mode information would be broken into 100 subsets. The earliest acquired 20 megacounts would form a first subset, the next earliest 20 megacounts would form a second subset, and so on. When the 100^{th} subset was reached, with only 10 megacounts remaining, the 100^{th} subset would be formed of the latest-acquired 10 megacounts. For such an example, the 1^{st}-99^{th} subsets would have 20 megacounts.

At 306, an initial list mode image is generated using the list mode information. For example, each subset may be used in turn as part of an iterative update of a single image. In the illustrated embodiment, at 308, the subsets are used iteratively to update a reconstruction to generate the initial list mode image. An example of generation of an initial list mode image is provided by the first portion 210 of the method 200.

At 310, the initial list mode image is separately updated with each subset to generate corresponding modified list mode images. Accordingly, there is a separate modified list mode image for each subset, with each of the modified list mode images generated by updating the same initial list mode image with the different corresponding subsets. An example of the generation of different modified list mode images using the same initial list mode image is provided by the second portion 250 of the method 200. Accordingly, after 310 is performed, a plurality of modified list mode images (one for each subset) is generated.

At 312, a final image is generated using the modified list mode images. Generally, the modified list mode images are combined in a manner so as to address changes over time in the scanning process (as reflected in the subsets that are acquired chronologically). Accordingly, time information may be used to address time-related fluctuations in the data collected over a scan, including fluctuations caused by issues such as biologic kinetics of a radiotracer that vary for each patient and procedure. As only data from the particular scan is used, the modifications to address the time-related fluctuations are tailored for the particular scan. The modified list mode images may be combined by one or more of averaging and/or filtering processes.

For example, at 314, an averaging process is applied to the modified list mode images. The average may be a weighted average. As another additional or alternative example, at 316, a filtering process is applied to the modified list mode images. For example, one or more of a temporal filter, low pass filter, or high pass filter may be utilized. As another additional or alternative example, at 318, a root mean square is determined for the modified list mode images, and used to generate the final image.

FIG. 4 provides a schematic block view of an imaging system 400 formed in accordance with various embodiments. The imaging system 400 includes a positron emission tomography (PET) acquisition unit 410 and a processing unit 420. Generally, the PET acquisition unit is configured to acquire PET imaging information, and the processing unit 420 is configured to utilize the acquired PET imaging information to reconstruct an image. For example, the processing unit 420 in various embodiments is configured to utilize or implement one or more aspects of the method 100 and/or the method 200 and/or the method 300 to reconstruct an image.

The PET acquisition unit 410, for example, may include a ring of detectors encircling an object to be imaged (e.g., a patient (or portion thereof) that has been administered a radiotracer). The PET acquisition unit 410 in various embodiments is configured to detect coincidence events, or events along a line of flight detected by two opposed detectors, with the events generated from an annihilation event within the object being imaged. For additional discussion regarding PET imaging system, see, for example, FIG. 5 and the related discussion. Generally, the information from the PET acquisition unit 410 may include, for each event, a time of acquisition (e.g., a time referenced to a predetermined point such as the start of scan, or a time in a universal reference system), detectors impacted by the particular event, and time-of-flight information (e.g., a time difference between reception by two detectors that may be used to establish a location for the event along the line between the two detectors).

In the illustrated embodiment, the processing unit 420 is operably coupled to the PET acquisition unit 140, and is configured to acquire list mode information from the PET acquisition unit 410. The list mode information includes time information (e.g., information describing or corresponding a time of acquisition for each particular coincidence event relative to the other coincidence events). The time information, for example, may be utilized to group acquired events into chronologically ordered subsets of events. Accordingly, the processing unit 420 is also configured to divide the list mode information into subsets using the time information. It may be noted that the system 400, similar to the flowchart of method 100 and other illustrated embodiments discussed herein, is discussed in relation to an example embodiment using list mode information and list mode images; however, other types of scanning information and/or reconstruction techniques (e.g., use of sinograms) may be used in other embodiments.

Additionally, the processing unit 420 is further configured to use the time information to modify the list mode information, and to use the modified information to generate an image. For example, in the illustrated embodiment, the processing unit 420 is configured to generate an initial list mode image using the list mode information, separately update the initial list mode image with each subset to generate corresponding modified list mode images, and generate a final image using the modified list mode images. By using the time information, the imaging system 400 (e.g., the processing unit 420 of the imaging system 400) is able to exploit the time information to address variances or fluctuations in imaging over time (e.g., due to biologic kinetics of a radiotracer for a particular scan) to improve final image quality.

It may be noted that in various embodiments the processing unit 420 includes processing circuitry configured to perform one or more tasks, functions, or steps discussed herein. It may be noted that “processing unit” as used herein is not intended to necessarily be limited to a single processor or computer. For example, the processing unit 420 may include multiple processors, ASIC's, FPGA's, and/or computers, which may be integrated in a common housing or unit, or which may distributed among various units or housings. It may be noted that operations performed by the processing unit 420 (e.g., operations corresponding to process flows or methods discussed herein, or aspects thereof) may be sufficiently complex that the operations may not be performed by a human being within a reasonable time period.

The depicted processing unit 420 includes a memory 422. The memory 422 may include one or more computer readable storage media. The memory 422, for example, may store mapping information describing detector locations, acquired emission information including list mode information, image data corresponding to images generated, results of intermediate processing steps, reconstruction parameters or reconstruction information (e.g., reconstruction information corresponding to the particular PET acquisition unit 410 used to acquire imaging information), or the like. Further, the process flows and/or flowcharts discussed herein (or aspects thereof) may represent one or more sets of instructions that are stored in the memory 422 for direction of operations of the imaging system 400.

FIGS. 5-7 illustrate a PET imaging system with which various embodiments described herein may be employed. In other embodiments, crystal arrays as discussed herein may be utilized with other imaging systems (e.g., imaging systems configured for one or more additional or alternative modalities). FIG. 5 illustrates a PET scanning system 1 including a gantry 10 that supports a detector ring assembly 11 about a central opening or bore 12. The detector ring assembly 11 in the illustrated embodiments is generally circular and is made up of plural rings of detectors spaced along a central axis 2 to from a cylindrical detector ring assembly. In various embodiments, the detector ring assembly 11 may include 5 rings of detectors spaced along the central axis 2. A patient table 13 is positioned in front of the gantry 10 and is aligned with the central axis 2 of the detector ring assembly 11. A patient table controller (not shown) moves the table bed 14 into the bore 12 in response to commands received from an operator work station 15 through a communications link 16. A gantry controller 17 is mounted within the gantry 10 and is responsive to commands received from the operator work station 15 through a second communication link 18 to operate the gantry.

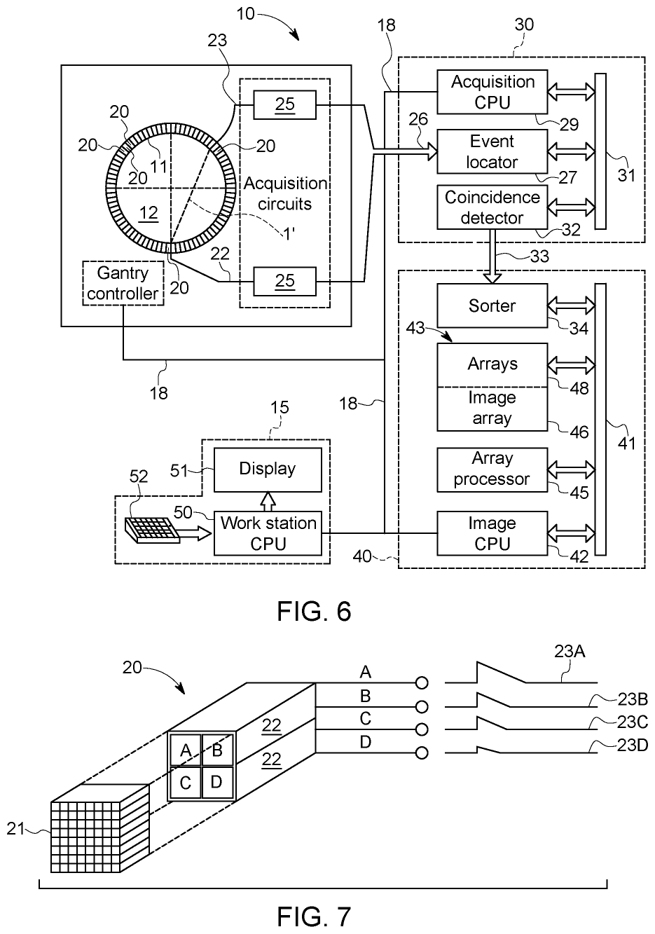

As shown in FIG. 6, the operator work station 15 includes a central processing unit (CPU) 50, a display 51, and a keyboard 52. An operator may use the keyboard to control the calibration of the PET scanner, the configuration of the PET scanner, and the positioning of the patient table for a scan. Also, the operator may control the display of the resulting image on the display 51 and/or perform image enhancement functions using programs executed by the work station CPU 50.

The detector ring assembly 11 includes a number of detector modules. For example, the detector ring assembly 11 may include 36 detector modules, with each detector module including eight detector blocks. An example of one detector block 20 is shown in FIG. 5. The detector blocks 20 in a detector module may be arranged, for example, in a 2×4 configuration such that the circumference of the detector ring assembly 11 is 72 blocks around, and the width of the detector assembly 11 is 4 detector blocks wide. Each detector block 20 may include a number of individual detector crystals. In the illustrated embodiment, the array of detector crystals 21 is situated in front of four photosensors 22. The photosensors 22 are depicted schematically as photomultiplier tubes; however, it may be noted that SiPM's may be employed in various embodiments. Other configurations, sized and numbers of detector crystals, photosensors and detector modules may be employed in various embodiments.

During a PET scan, an annihilation photon may impact one of the detector crystals 21. The detector crystal 21, which may be formed, for example of lutetium yttrium silicate (LYSO) or bismuth germinate (BGO), for example, converts the annihilation photon into a number of photons which are received and detected by the photosensors. The photons generated by a detector crystal generally spread out to a certain extent and travel into adjacent detector crystals such that each of the four photosensors 22 receives a certain number photons as a result of an annihilation photon impacting a single detector crystal 21.

In response to a scintillation event, each photosensor 22 produces a signal 23A-23D on one of the lines A-D, as shown in FIG. 7, which rises sharply when a scintillation event occurs and then tails off exponentially. The relative magnitudes of the signals are determined by the position in the detector crystal array at which the scintillation event took place. The energy of the annihilation photon which caused the scintillation event determines the total magnitude of the four signals. The time that the signal begins to rise is determined by when the scintillation event occurs and the time required for photons to travel from the position of the scintillation event to the photosensors. The example depicted in FIG. 7 provides an example based on a vacuum photodetector; however, it may be noted that certain principles disclosed herein may also be applied to SiPM detectors generally.

As shown in FIG. 6, a set of acquisition circuits 25 is mounted within the gantry 10 to receive the four signals from the detector block 20. The acquisition circuits 25 determine timing, energy and the event coordinates within the array of detector crystals using the relative signal strengths. The results are digitized and sent through a cable 26 to an event locator circuit 27 housed in a separate cabinet 28. Each acquisition circuit 25 also produces an event detection pulse which indicates the exact moment the scintillation event took place.

The event locator circuits 27 form part of a data acquisition processor 30 which periodically samples the signals produced by the acquisition circuits 25. The data acquisition processor 30 has an acquisition CPU 29 which controls communications on the local area network 18 and a bus 31. The event locator circuits 27 assemble the information regarding each valid event into a set of digital numbers that indicated when the event took place and the identity of the detector crystal 21 which detected the event. The event locator circuits 27, for example, may use a detector position map to map a pair of coordinates to the detector 21 which detected the event.

The event data packets are transmitted to a coincidence detector 32 which is also part of the data acquisition processor 30. The coincidence detector 32 accepts the event data packets from the event locator circuits 27 and determines if any two of them are in coincidence. Coincidence is determined by a number of factors. For example, time markers in each event data packet may be required to be within a specified time period of each other, e.g., 6 nanoseconds. As another example, the locations indicated by the two event data packets may be required to lie on a straight line which passes through the field of view (FOV) of in the scanner bore 12. Events which cannot be paired are discarded, but coincidence event pairs are located and recorded as a coincidence data packet that is transmitted through a serial link 33 to a sorter 34. The format of the coincidence data packet may be, for example, a forty-eight bit data packet which includes, among other things, a pair of digital numbers that precisely identify the locations of the two detector crystals 21 that detected the event.

The sorter 34, which may include a CPU and which forms part of an image reconstruction processor 40, receives the coincidence data packets from the coincidence detector 32. The function of the sorter 34 is to receive the coincidence data packets and allocate memory for the storage of the coincidence data. During an emission scan, the coincidence counts are organized in memory 43.

Coincidence events occur at random and the sorter 34 determines corresponding information for each coincidence data packet and increments the count of the corresponding array element. At the completion of the emission scan, the array 48 stores the total number of annihilation events. The array processor 45 reconstructs an image from the data in the array 48. The image CPU 42 may either store the image array data or output the data to the operator work station 15.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid-state drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation. For example, a processing unit, processor, or computer that is “configured to” perform a task or operation may be understood as being particularly structured to perform the task or operation (e.g., having one or more programs or instructions stored thereon or used in conjunction therewith tailored or intended to perform the task or operation, and/or having an arrangement of processing circuitry tailored or intended to perform the task or operation). For the purposes of clarity and the avoidance of doubt, a general purpose computer (which may become “configured to” perform the task or operation if appropriately programmed) is not “configured to” perform a task or operation unless or until specifically programmed or structurally modified to perform the task or operation.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f) unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. A method comprising:
acquiring scanning information for a positron emission tomography (PET) scan, the scanning information comprising time information;
generating imaging information using the scanning information;
modifying the imaging information using the time information to generate modified imaging information; and
reconstructing an image using the modified imaging information.

2. The method of claim 1, wherein generating the imaging information comprises reconstructing an initial image.

3. The method of claim 2, further comprising dividing the scanning information into subsets using the time information, and iteratively using the subsets to generate the initial image.

4. The method of claim 3, wherein a number of the subsets contain a common number of counts.

5. The method of claim 2, further comprising dividing the scanning information into subsets using the time information, and wherein modifying the imaging information comprises separately updating the initial image with each subset to generate corresponding modified images.

6. The method of claim 5, wherein modifying the imaging information comprises combining the modified images using at least one of a filtering or an averaging.

7. A method comprising:
acquiring scanning information for a positron emission tomography (PET) scan, the scanning information comprising time information;
dividing the scanning information into subsets using the time information;
generating an initial image using the scanning information;
separately updating the initial image with each subset to generate corresponding modified images; and
generating a final image using the modified images.

8. The method of claim 7, wherein generating the initial image comprises iteratively using the subsets to iteratively update a reconstruction to generate the initial image.

9. The method of claim 7, wherein a number of the subsets contain a common number of counts.

10. The method of claim 9, wherein the common number of counts is 5 megacounts or more.

11. The method of claim 7, wherein generating the final image comprises applying an averaging process to the modified images.

12. The method of claim 7, wherein generating the final image comprises applying a filtering process to the modified images.

13. The method of claim 7, wherein generating the final image comprises determining a root mean square for the modified images, and utilizing the root mean square to generate the final image.

14. A system comprising:
a positron emission tomography (PET) acquisition unit configured to acquire PET imaging information; and
at least one processor operably coupled to the PET acquisition unit, the at least one processor configured to:
acquire scanning information from the PET acquisition unit, the scanning information comprising time information;
divide the scanning information into subsets using the time information;
generate an initial image using the scanning information;
separately update the initial image with each subset to generate corresponding modified images; and
generate a final image using the modified images.

15. The system of claim 14, wherein the at least one processor is configured to generate the image by iteratively using the subsets to iteratively update a reconstruction to generate the initial image.

16. The system of claim 15, wherein a number of the subsets contain a common number of counts.

17. The system of claim 16, wherein the common number of counts is 5 megacounts or more.

18. The system of claim 14, wherein the at least one processor is configured to generate the final image by applying an averaging process to the modified images.

19. The system of claim 14, wherein the at least one processor is configured to generate the final image by applying a filtering process to the modified images.

20. The system of claim 14, wherein the at least one processor is configured to generate the final image by determining a root mean square for the modified images, and to utilize the root mean square to generate the final image.
